(19) United States
(12) Patent Application Publication
(10) Pub. No.: US 2019/0270147 A1
(43) Pub. Date: Sep. 5, 2019

(54) DUST-COLLECTING PLANT OF A CIRCULAR SAWING MACHINE

(71) Applicant: Bor-Yann CHUANG, Taichung (TW)

(72) Inventor: Bor-Yann CHUANG, Taichung (TW)

(21) Appl. No.: 15/909,465

(22) Filed: Mar. 1, 2018

(51) Int. Cl. B23D 59/00; B23Q 11/00

(52) U.S. Cl. CPC B23D 59/006; B23Q 11/0057

(57) ABSTRACT

A dust-collecting plant of a circular sawing machine is combined with a circular sawing machine, which contains a machine base and a working platform. The dust-collecting plant includes an upper fundamental seat, a slide seat and a lower fundamental seat. The upper fundamental seat is provided with plural slide rods inserted out of the slide seat, which has one side provided with a transmission unit containing a saw blade and another side disposed with a dust-collecting plant containing an accommodating groove and a dust-collecting mouth. The lower fundamental seat is fixed at another end of the slide rods and provided with a lifting unit for moving the slide seat up and down. When the slide seat is moved up and down, the saw blade and the dust-collecting mouth can maintain equidistance, letting scraps sawed eject directly to the dust-collecting mouth for enhancing efficiency of dust collection.

### BACKGROUND OF THE INVENTION

### 1. Field of the Invention

This invention relates to a dust-collecting plant, particularly to the dust-collecting plant of a circular sawing machine.

### 2. Description of the Prior Art

A conventional circular sawing machine, as shown in FIGS. 1, 2 and 3, includes a machine base 1 provided with a stationary seat 2, a slide seat 3 and a lifting unit 4. The stationary seat 2 is fixedly provided with a dust-collecting hood 5 formed with a dust-collecting mouth 6, which is connected with a dust collector (not shown). The slide seat 3 is provided with a transmission unit 7 connected with a saw blade 8, which is partially covered by the dust-collecting hood 5. The slide seat 3 is connected with the stationary seat 2 and the lifting unit 4, able to be moved up and down via the lifting unit 4. Thus, scraps produced when the saw blade 8 is sawing a work piece, will be gathered by the dust-collecting hood 5 and then exhausted to the dust collector through the dust-collecting mouth 6 so that the interior of the circular sawing machine can be kept clean.

However, since the conventional dust-collecting hood 5 is immovably fixed on the stationary seat 2, and the saw blade 8 has to be adjusted in height according to sawing demands; therefore, spacing between the dust-collecting hood 5 and the saw blade 8 will be changed. When the spacing between the dust-collecting hood 5 and the saw blade 8 is too large, the rotating direction of the saw blade 8 and the dust-collecting mouth 6 will not be aligned, and as a result, the scraps will hit the inner wall of the dust-collecting hood 5 and the scraps produced during sawing will be accumulated in the interior of the circular sawing machine to affect dust collection effect when the saw blade 8 carries out sawing. Having observed the above-mentioned defect, the inventor of this invention thinks that the conventional dust-collecting hood is necessary to be ameliorated and hence devises this invention.

### SUMMARY OF THE INVENTION

The objective of this invention is to offer a dust-collecting plant of a circular sawing machine. In the present invention, the dust-collecting plant and the saw blade of a circular sawing machine can be moved up and down synchronously for enhancing dust collection effect of the circular sawing machine.

The dust-collecting plant is combined with a circular sawing machine, which contains a machine base and a working platform. The dust-collecting plant includes an upper fundamental seat, a slide seat and a lower fundamental seat. The upper fundamental seat is firmly secured with the working platform and provided with plural slide rods. The slide seat is formed with plural through holes respectively corresponding to the slide rods for the slide rods to be inserted therethrough and bored with a threaded hole. Further, the slide seat has a first side face provided with a transmission unit containing a motor and a saw blade, and a second side face mounted with dust-collecting plant containing an accommodating groove and a dust-collecting mouth, the accommodating groove formed with an opening, while the saw blade having a part received in the accommodating groove. The lower fundamental seat is firmly fixed at another ends of the slide rods and provided with a lifting unit, which consists of a screw rod and a control rod. The screw rod has one end threadably fixed with the threaded hole of the slide seat, and the control rod can be controlled to drive the screw rod to rotate and actuate the slide seat to move up and down.

The dust-collecting plant of a circular sawing machine in the present invention is able to have the saw blade of the slide seat and the dust-collecting plant moved up and down synchronously when height of the saw blade is adjusted via the lifting unit. By so designing, the saw blade and the dust-collecting plant can maintain equidistance to enable the scraps sawed to eject directly to the dust-collecting mouth for elevating efficiency of dust collection.

### BRIEF DESCRIPTION OF DRAWINGS

This invention will be better understood by referring to the accompanying drawings, wherein:

FIG. 1 is a perspective view of a conventional circular sawing machine;

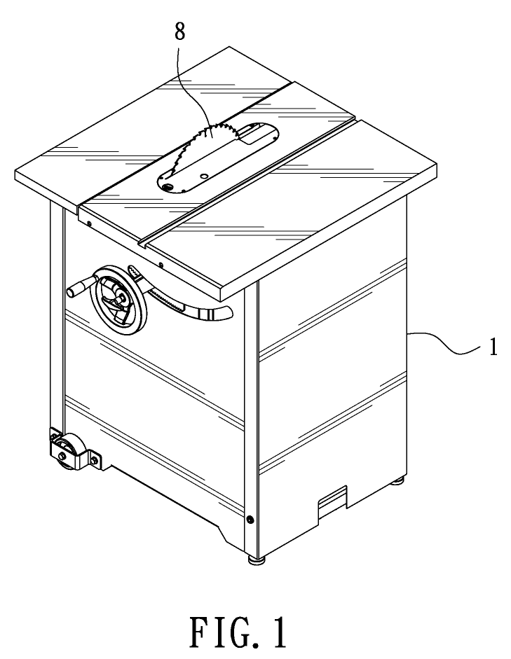

FIG. 2 is a partial exploded perspective view of a dust-collecting plant of the conventional circular sawing machine;

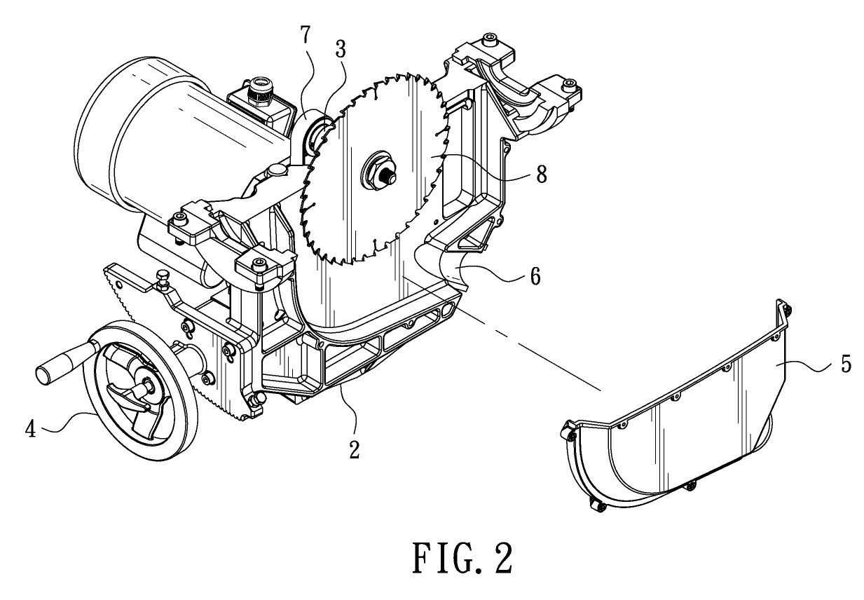

FIG. 3 is a longitudinal sectional view of the conventional circular sawing machine;

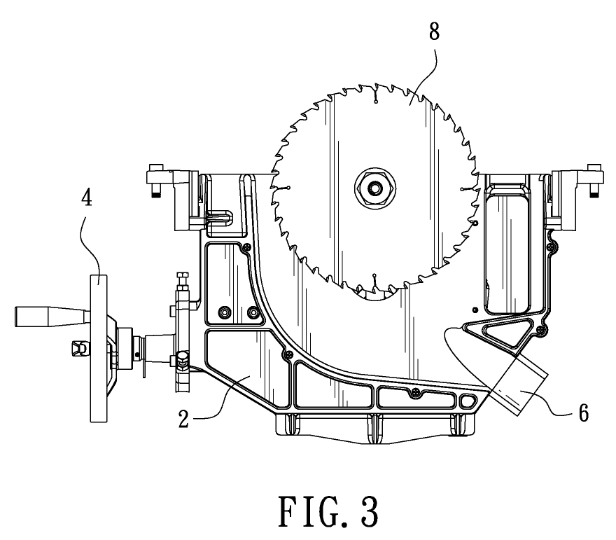

FIG. 4 is a perspective view of a circular sawing machine in the present invention;

FIG. 5 is a perspective view of a dust-collecting plant of the circular sawing machine in the present invention;

FIG. 6 is a partial exploded perspective view of the dust-collecting plant of the circular sawing machine in the present invention, showing an exploded state of the dust-collecting plant and the saw blade;

FIG. 7 is a partial exploded perspective view of the dust-collecting plant of the circular sawing machine in the present invention, showing an exploded pattern of an upper fundamental seat, a slide seat and a lower fundamental seat;

FIG. 8 is a side view of the dust-collecting plant of a circular sawing machine in the present invention;

FIG. 9 is a schematic view of the dust-collecting plant of the circular sawing machine in use in the present invention, showing a state of dust collection of the circular sawing machine; and

FIG. 10 is a schematic view of the dust-collecting plant of the circular sawing machine in use in the present invention, showing a state of dust collection when the saw blade is adjusted in height.

### DETAILED DESCRIPTION OF THE PREFERRED EMBODIMENT

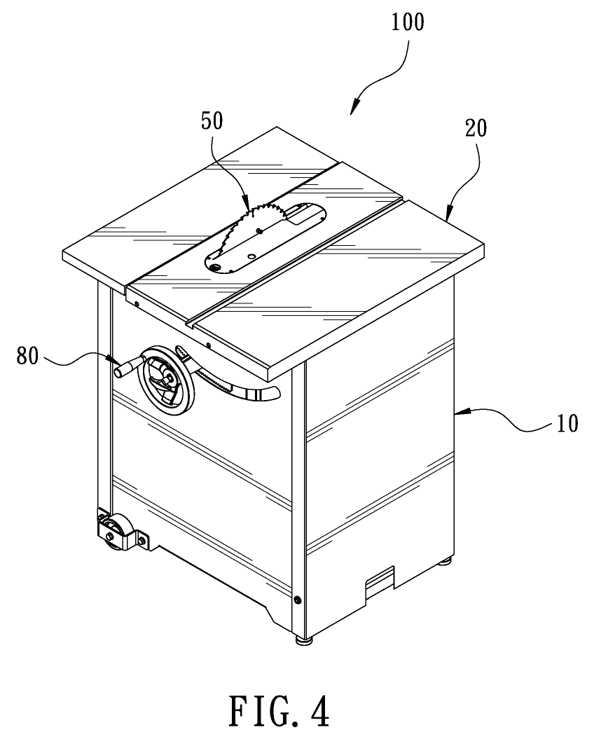

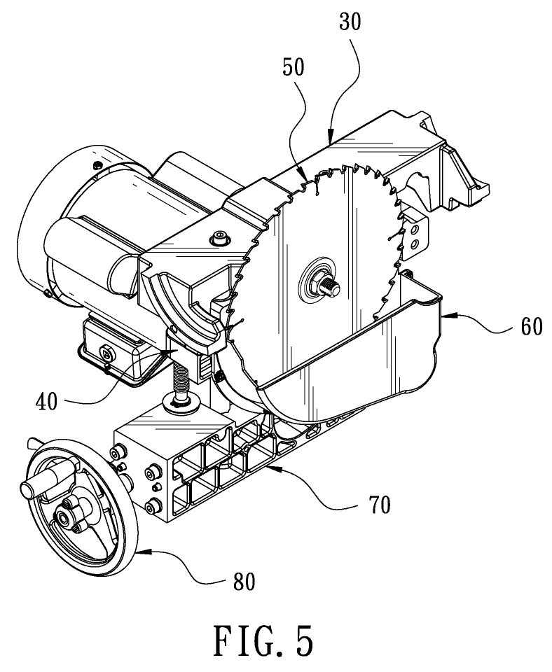

A preferred embodiment of a dust-collecting plant of a circular sawing machine in the present invention, as shown in FIGS. 4, 5 and 6, is combined with a circular sawing machine 100 that contains a machine base 10 and a working platform 20. The dust-collecting plant of a circular sawing machine includes an upper fundamental seat 30, a slide seat 40, and a lower fundamental seat 70 combined together.

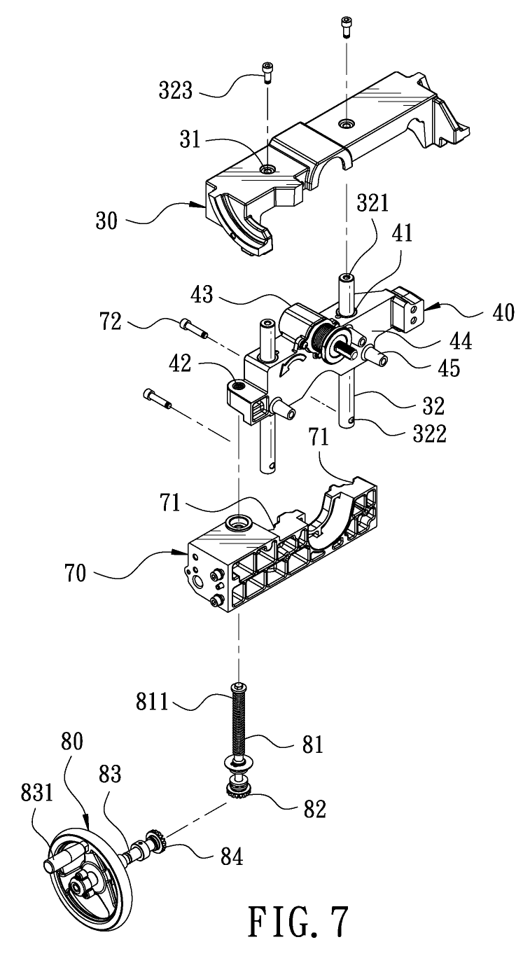

The upper fundamental seat 30, referring to FIG. 7, is firmly fixed with the working platform 20 and bored with two fixing holes 31 respectively inserted therein with a slide rod 32, and further provided with two bolts 323 to have the first ends 321 of the slide rods 32 respectively secured with the fixing holes 31 of the upper fundamental seat 30.

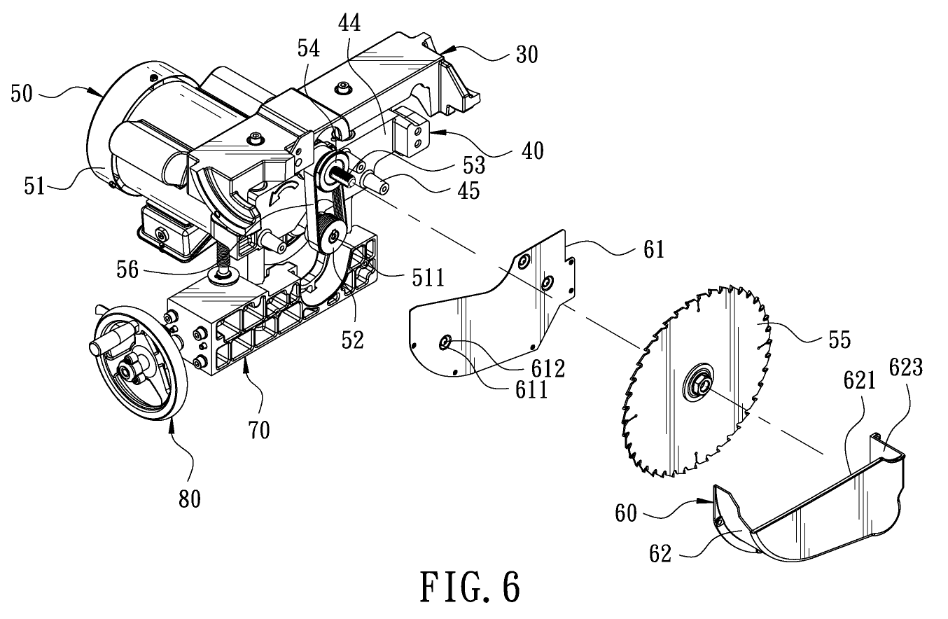

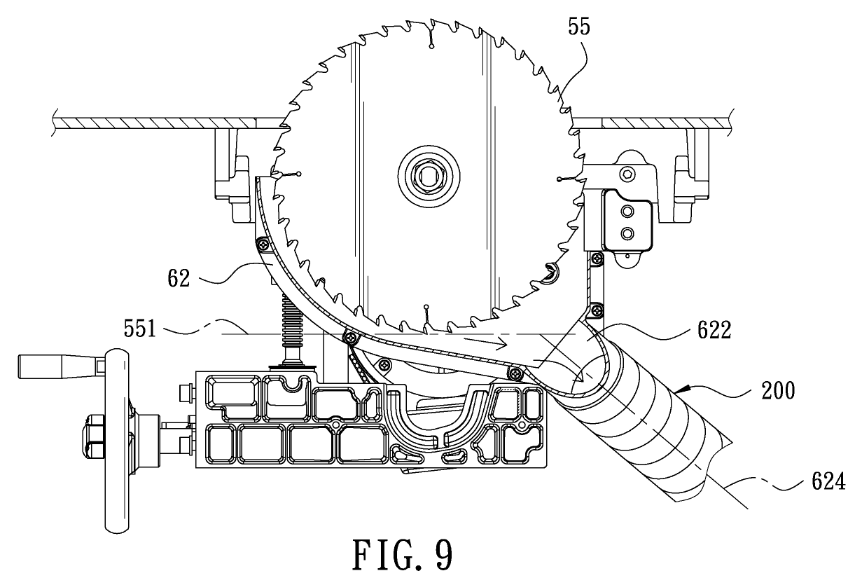

The slide seat 40 is bored with two through holes 41 respectively corresponding to the two slide rods 32 to let the slide rods 32 inserted out of the through holes 41, and further bored with a threaded hole 42. Referring to FIGS. 6, 7 and 8, the slide seat 40 has a first side face 43 provided with a transmission unit 50 containing a motor 51, which has a driving shaft 511 fitted thereon with a first transmission wheel 52. The slide seat 40 is further inserted therein with a driven shaft 53 fitted thereon with a second transmission wheel 54 and a saw blade 55. A driving belt 56 is fitted around the first transmission wheel 52 and the second transmission wheel 54 to enable the driving shaft 511 and driven shaft 53 to rotate synchronously and make the driving shaft 511 of the motor 51 actuate the saw blade 55 to rotate via the driving belt 56. Further, the second side face 44 of the slide seat 40 is provided with fixing members 45, which are three pillars in this preferred embodiment, and the fixing members 45 are fixed with a dust-collecting plant 60, which consists of a plate 61 and a hood 62. The plate 61 is bored with insert holes 611 corresponding to the fixing members 45 and respectively locked with the fixing members 45 by means of bolts 612. The hood 62 is secured with the plate 61 and provided with an accommodating groove 621 and a dust-collecting mouth 622, the accommodating groove 621 formed with an opening 623. The saw blade 55 is positioned between the plate 61 and the hood 62 and is partially received in the accommodating groove 621. Referring to FIG. 9, the axis 624 of the dust-collecting mouth 622 and the tangential direction 551 of the saw blade 55 intersect with each other so that scraps sawed by the saw blade 55 can eject directly to the dust-collecting mouth 622 for enhancing efficiency of dust collection.

The lower fundamental seat 70 is fixedly provided at the second ends 322 of the slide rods 32. Referring to FIGS. 6, 7 and 8, the lower fundamental seat 70 is formed with two fixing grooves 71 to be respectively locked with the second ends 322 of the slide rods 33 by two bolts 72 and further provided with a lifting unit 80, which consists of a screw rod 81 that is inserted through the lower fundamental seat 70 and a control rod 83. The screw rod 81 has one end inserted out of the lower fundamental seat 70 and provided with a first bevel gear 82. The thread part 811 of the screw rod 81 is threadably fixed in the threaded hole 42 of the slide seat 40. The control rod 83 is provided with a handle 831 and has its free end disposed with a second bevel gear 84 to be engaged with the first bevel gear 82. Thus, when the handle 831 is turned, the control rod 83 and the screw rod 81 will be actuated to rotate to enable the slide seat 40 to move up and down.

In use of the circular sawing machine, referring to FIG. 9, firstly, the dust-collecting mouth 622 of the hood 62 is connected with a dust collector (not shown) by means of a dust-collecting tube 200 and then, referring to FIG. 6, the driving shaft 511 of the motor 51 is started to rotate to make use of the first transmission wheel 52 actuate the second transmission wheel 54 together with the saw blade 55 to rotate via the driving belt 56. When the saw blade 55 is sawing a work piece, the scraps produced will directly eject to the dust-collecting mouth 622 of the hood 62 and then will be collected by the dust collector. By so designing, the saw blade 55 and the dust-collecting plant 60 are able to maintain equidistance so that the scraps sawed by the saw blade 55 can eject directly to the dust-collecting mouth 622 for elevating efficiency of dust collection.

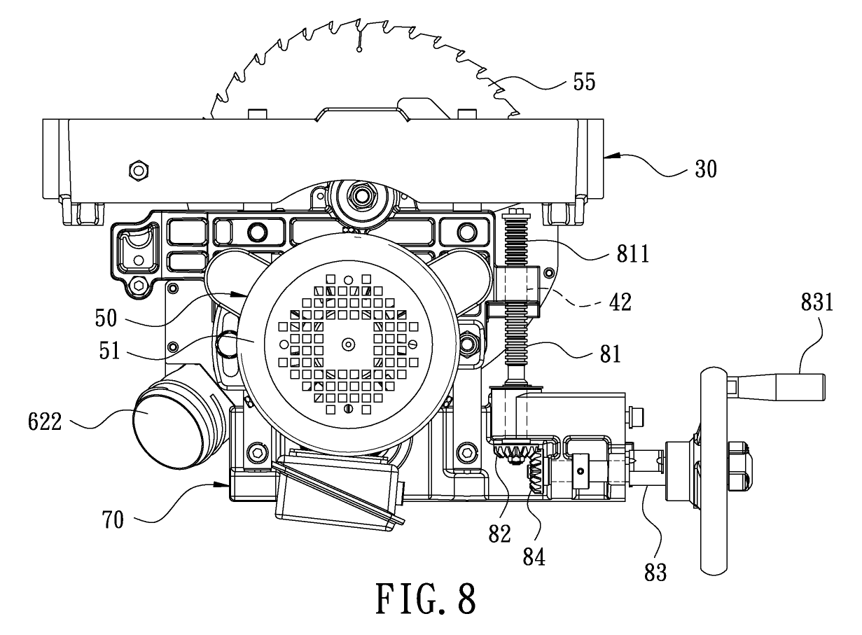

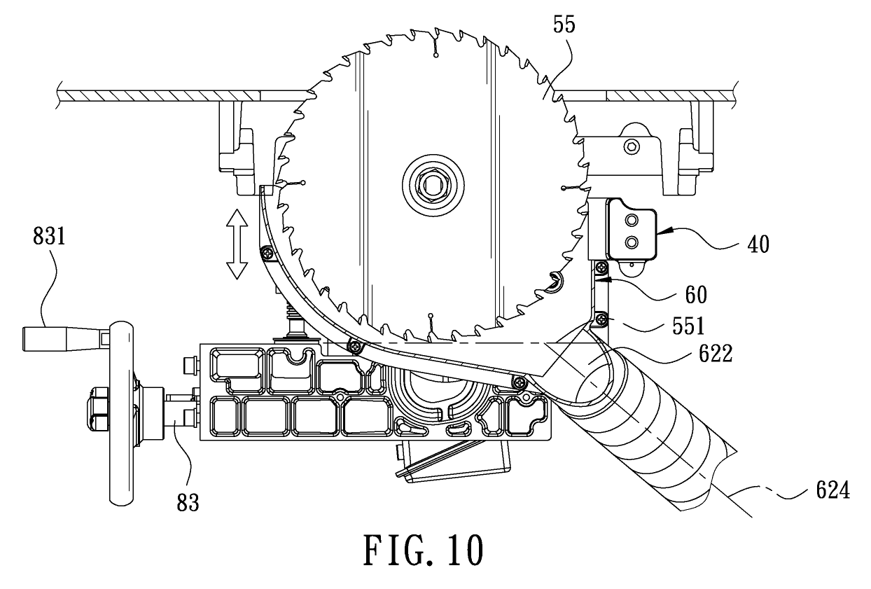

Referring to FIGS. 8 and 10, when the saw blade 55 is to be moved up and down, the handle 831 is turned to drive the control rod 83 to rotate to have the second bevel gear 84 actuating the first bevel gear 82 to rotate and make the slide seat 40 and the saw blade 55 and the dust-collecting plant 60 move up and down synchronously, enabling the saw blade 55 and the dust-collecting plant 60 to maintain equidistance and letting the axis 624 of the dust-collecting mouth 622 and the tangential direction 551 of the saw blade 55 intersect with each other. Thus, the scraps sawed by the saw blade 55 can eject directly to the dust-collecting mouth 622 for enhancing efficiency of dust collection.

One thing worth mentioning is that the lower upper fundamental seat 30, the slide seat 40 and the lower fundamental seat 70 of the dust-collecting plant 60 are simple in structure; therefore, the upper fundamental seat 30, the slide seat 40 and the lower fundamental seat 70 can be processed conveniently and precisely.

Another thing worthy of mentioning is that the fixing members 45 of the slide seat 40 are three pillars, which can firmly fix the dust-collection plant 60 containing the plate 61 and the hood 62, able to lessen the gap between the saw blade 55 and the dust-collection plant 60 and elevate negative pressure of the dust-collection mouth 622 for enhancing efficiency of dust collection.

While the preferred embodiment of the invention has been described above, it will be recognized and understood that various modifications may be made therein and the appended claims are intended to cover all such modifications that may fall within the spirit and scope of the invention.

What is claimed is:

1. A dust-collection plant of a circular sawing machine combined with a circular sawing machine, said circular sawing machine comprising a machine base and a working platform, said dust-collection plant of a circular sawing machine comprising:
an upper fundamental seat secured with said working platform, said upper fundamental seat provided with plural slide rods;
a slide seat bored with plural through holes respectively corresponding to said slide rods for said slide rods to be inserted therethrough, said slide seat bored with a threaded hole, said slide seat having a first side face provided with a transmission unit, said transmission unit comprising a motor and a saw blade, said slide seat having a second side face provided with a dust-collecting plant, said dust-collecting plant comprising an accommodating groove and a dust-collecting mouth, said accommodating groove formed with an opening, said saw blade having a part received in said accommodating groove; and
a lower fundamental seat fixed at another end of said slide rods, said lower fundamental seat provided with a lifting unit, said lifting unit comprising a screw rod and a control rod, said screw rod having one end threadably fixed with said threaded hole of said slide seat, said screw rod driven by said control rod to rotate and actuate said slide seat to move up and down.

2. The dust-collecting plant of a circular sawing machine as claimed in claim 1, wherein said slide seat has a second side face set with fixing members, said fixing members being three pillars, said fixing members provided with said dust-collecting plant, said dust-collecting plant comprising a plate and a hood, said plate bored with insert holes corresponding to said fixing members, said insert holes locked with said fixing members by means of bolts, said hood secured with said plate, thus lessening spacing between said dust-collecting plant and said saw blade for enhancing effect of dust collection.

3. The dust-collecting plant of a circular sawing machine as claimed in claim 1, wherein axis of said dust-collecting mouth and tangential direction of said saw blade intersecting each other.

4. The dust-collecting plant of a circular sawing machine as claimed in claim 1, wherein said motor is provided with a driving shaft, said driving shaft fitted thereon with a first transmission wheel, said slide seat inserted therein with a driven shaft, said driven shaft fixed thereon with a second transmission wheel and said saw blade, said first transmission wheel and said second transmission wheel fitted thereon with a driving belt to enable said driving shaft and said driven shaft to rotate synchronously.

5. The dust-collecting plant of a circular sawing machine as claimed in claim 1, wherein said screw rod has one end inserted out of said lower fundamental seat and provided with a first bevel gear, said control rod formed with a handle, said control rod having a free end provided with a second bevel gear, said first bevel gear engaged with said second bevel gear, said handle turned to actuate both said control rod and said screw rod to rotate.
